(19) United States
(12) Patent Application Publication
(10) Pub. No.: US 2008/0230564 A1
(43) Pub. Date: Sep. 25, 2008

(54) Always spray tubing with weight

(76) Inventor: Stacy Jay, Brown Deer, WI (US)

Correspondence Address: STACY JAY, 4514 W DUNWOOD RD, BROWN DEER, WI, 53223, US

(21) Appl. No.: 11/788,647

(22) Filed: Apr. 20, 2007

Related U.S. Application Data
(60) Provisional application No. 60/905,174, filed on Mar. 6, 2007.

(51) Int. Cl. B67D 5/40

(52) U.S. Cl. 222/383.1

(57) ABSTRACT

Always Spray Tubing with Weight is an attachment for any manual, mechanical, battery, or electric dispensing apparatus. The flexible part of the piece allows the end, which is weighted to move freely with the motion of the liquid or substance used. The weighted end is more dense than the substance or liquid applied to which allows the weight to remain submerged. The weighted end has a hollow center which allows passage of liquid or substance through to flexible tubing.

### BACKGROUND

1. Field of Invention

This invention relates to rigid dip tubes, such tubes attached to manual dispensers which are typically used on spray bottles.

2. Prior Art

There is a rigid dip tube that is attached to the end of a spray nozzle or dispensing device which is located inside the container and submerged in the liquid or substance. The rigid tube allows the liquid to travel from the inside of the bottle up and out through way of a spray nozzle or dispensing device. Originally these produced desired results until the bottle was tilted in the direction intended for product use, for example horizontal, therefore the rigid tube was no longer submerged in the liquid. This would prevent the liquid from coming out of the spray nozzle sufficiently also diminishing yield of product which in turn is more costly to consumers. Thereafter, several types of flexible tubes with weights were designed to remain in liquid to allow proper dispensing. U.S. Pat. No. 5,934,519 to Kim (1999) discloses a weighted dip tube or straw. The straw is flexible at two points, which is not able to retrieve contents if the bottles orientation was inverted or the like. Also there are many different parts which in turn raises assembly and manufacturing costs. U.S. Pat. No. 6,394,319 (2002) to Pucillo, suggests a flexible feeding assembly with weight that comes in a kit as an after market product for consumers to purchase. This consists of more packaging and shipping costs. It also suggests that the consumer replace the already installed rigid tube with the invention which could cause harm to the consumer especially when dealing with chemicals which is the most common application for the invention.

Pucillos invention also suggests holes on the side of the tubing which would not produce sufficient flow of product producing undesirable results.

Also, it is produced mainly in two pieces which raises cost of assembly, casting, molds, and other processes of manufacture.

### SUMMARY

In accordance with one embodiment always spray tubing with weight comprises of a flexible tube which allows the weighted end to move freely with the liquid or substance to ensure proper dispensing regardless of the containers orientation.

### DRAWINGS

FIG. 1A represents the Always Spray Tubing with weight inside of a spray bottle which is one example of its use.

FIG. 1B represents the Always Spray Tubing with Weight when the bottle is tilted in a horizontal direction.

FIG. 1. represents the Always Spray Tubing with Weight with one version of the dimensions of the weighted end, also the shape of the hole through center. Shown as one piece.

FIG. 2 represents the invention with another example of the dimensions of the weighted end with another shape of the hole through center. Shown as one piece

FIG. 3 Shows the flexibility of the tube used

FIG. 4. Shows an example of the size and shape of the weight on its own.

FIG. 5. Although it can be larger depending on the application, this figure shows a shorter version on the flexible tubing.

FIG. 6. Although a smaller version can be used depending on the application, this figure shows a larger weighted end with conical shaped hole.

FIG. 7. Illustrates the inventions connections if it were to be used as two pieces. This Fig has a male adapter on the weight which connects to a flexible tube.

FIG. 8. Illustrates an example of the inventions weight having a female adaptor end. Also being used as two pieces.

### DRAWINGS—List of Reference numerals

1. spray nozzle dispenser
2. bottle being used as an example
3. liquid being dispensed
4. flexible tubing
5. liquid
6. weighted end
7. hole through center
8. male adapter
9. tube inside female connection on weight

### DETAILED DESCRIPTION

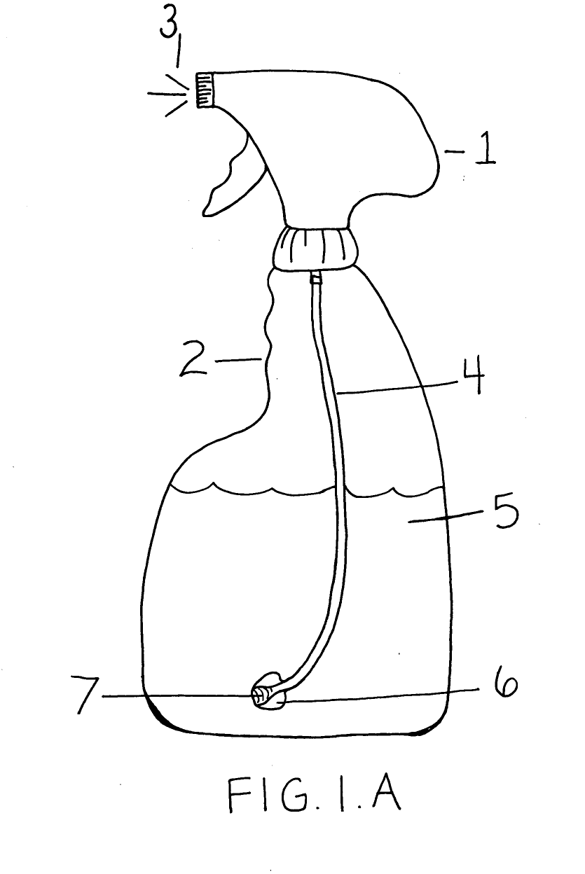

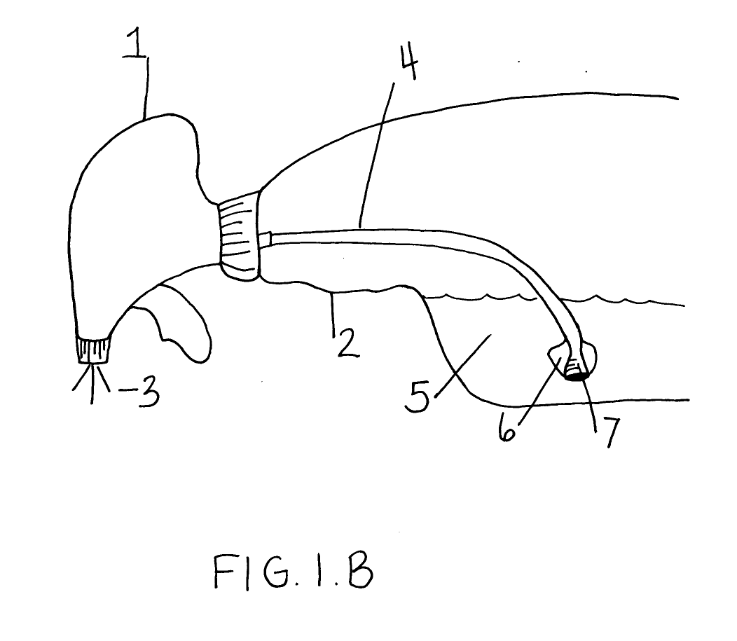

### FIG. 1.A and FIG. 1.B-First Embodiment

One embodiment of the Always Spray Tubing with Weight is the example of one of its uses in FIG. 1.A which represents the use inside of a spray bottle. The bottle 2 is equipped with a spray nozzle 1 which dispenses liquid 3 and 5 by way of a manual pump. All illustrations 1, 2, 3, and 5 are not included in said invention however are used here to give one example of its applications.

FIG. 1. B Shows the bottle 2 which is tilted in a horizontal direction. The liquid 5 is also horizontal. The extreme flexibility of the tubing 4 allows the weight 6 to remain submerged. This allows the hole 7 inside the weight 6 to also remain submerged in the liquid or substance. Furthermore, the liquid 5 can be dispensed by way of the spray nozzle 1 and will be dispensed 3 on desired location.

FIG. 1. Illustrates the always spray tubing with weight as one piece. The invention comprises of an extremely flexible part of the tube 4 which has a weighted end 6. This weighted end 6 has a hole through the center 7 which allows liquid 5 to pass up through the flexible tube 4. The flexible tube 4 allows the weighted end 6 to remain submerged in liquid or substance. The flexible tube 4 also allows the hole 7 through the center of the weight 6 to remain submerged allowing smooth flow of liquid 5 up through flexible tubing 4 and out of the dispensing device 1. When the bottle 2 used in this example is tilted horizontally as shown in FIG. 1. B. the flexible tube 4 allows the weighted end 6 that contains the hole through the center 7 to remain submerged. This in turn provides smooth flow of liquid 5 to desired location. Also prevents any aggravation or possible over spray of the product which would result in harm to consumer or harm to other objects or people nearby.

FIG. 1. Also illustrates one example of the shape that the weight 6 may be. This is an ‘acorn like’ shape which is very smooth on the outside producing smooth transition in the liquid 5 also it can glide easily over different shape containers which produces constant flow of liquid 5. Although there are many shapes that can be used, the acorn shape houses the majority of the weight 6 in the larger part which is needed to stay submerged. The weight 6 is made of any manmade, dissolvable or biodegradable material that is more dense than the liquid 5 or substance applied to, which allows weight 6 to remain submerged causing proper function of the invention.

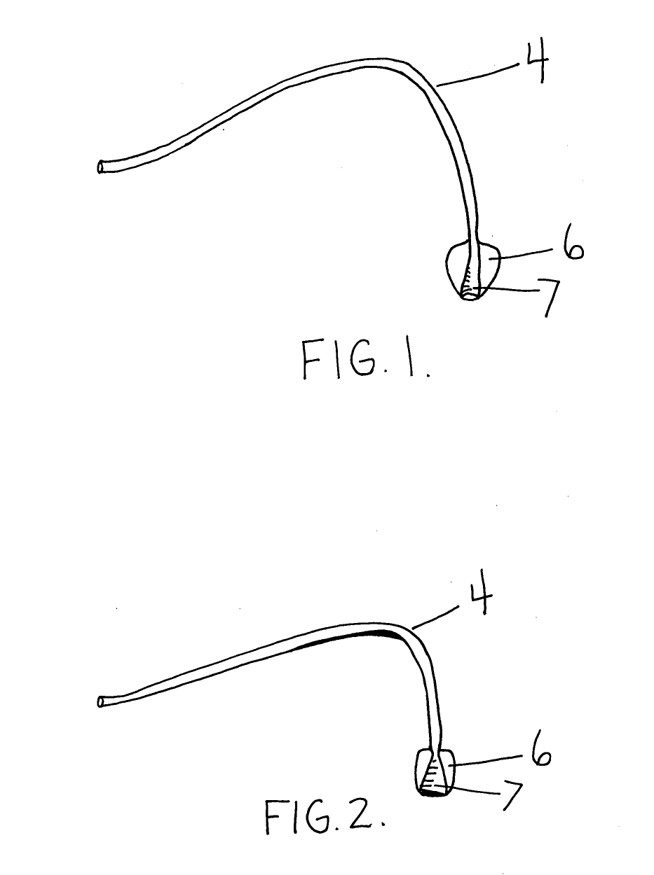

FIG. 2. Represents an illustration of the always spray tubing with weight as one piece which has a flexible tube 4 that connects to a weighted end 6. The weighted end has a hole through the center 7.

This example of the inventions shape has a conical hole through the center 7 which can be used to filter out debris. Simply by having a larger end at the opening of the hole 7 that continues to a smaller side can act as a filter which will prevent any debris from entering the flexible tube 4 when needed in certain applications. This simple design of the hole 7 keeps costs of manufacture low which benefits the manufacturing company as well as the consumer.

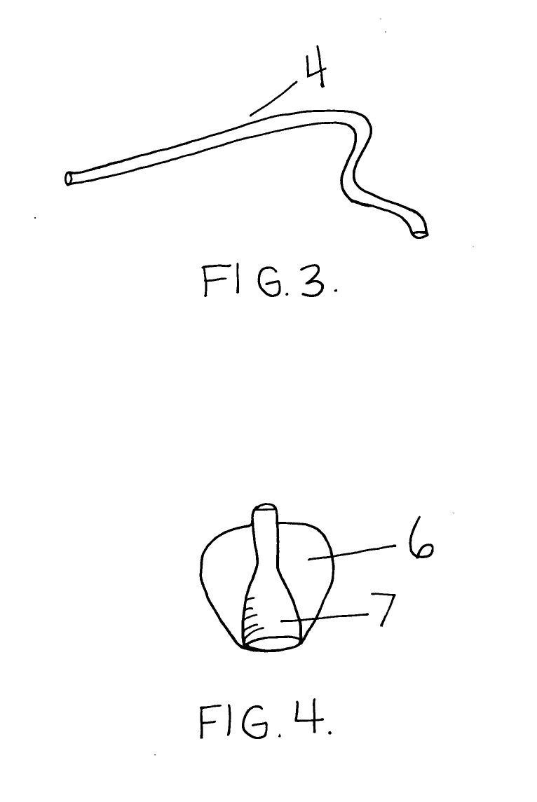

Another embodiment of the always spray tubing with weight is the extreme flexibility of the tube 4 which is shown in FIG. 3. This example of the tube is shown in two pieces. The tube 4 must be flexible enough to allow the weight 6 to move freely with the motion of the liquid. This causes the weight 6 to remain submerged in liquid regardless of the containers orientations.

FIG. 4. illustrates the weight 6 as one of the two pieces of the invention. The weight 6 has a hole through the center 7 which allows liquid to pass through and can be made of different shapes and sizes depending on the application.

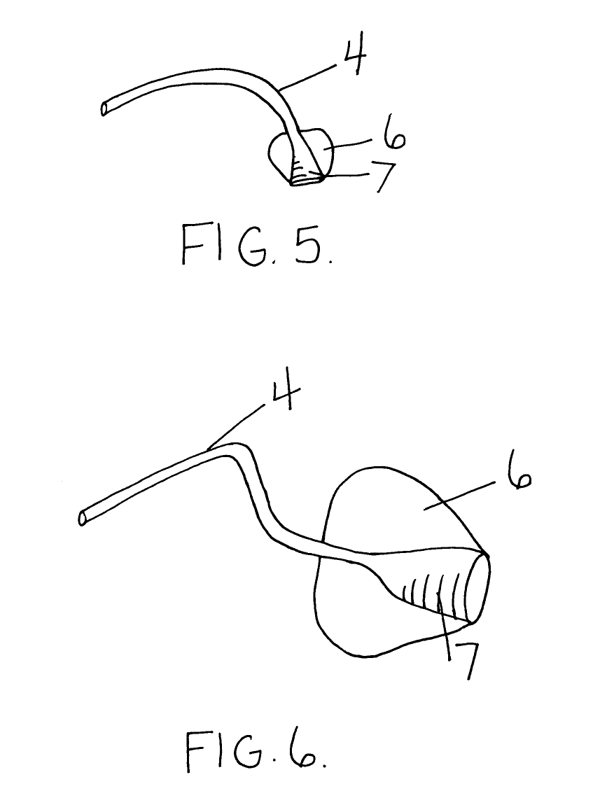

Although there are many sizes the flexible tube 4 may be depending on the application, FIG. 5. represents a shorter tube 4 as one piece which is connected to the weighted end 5 with a conical shaped hole 7 through the center.

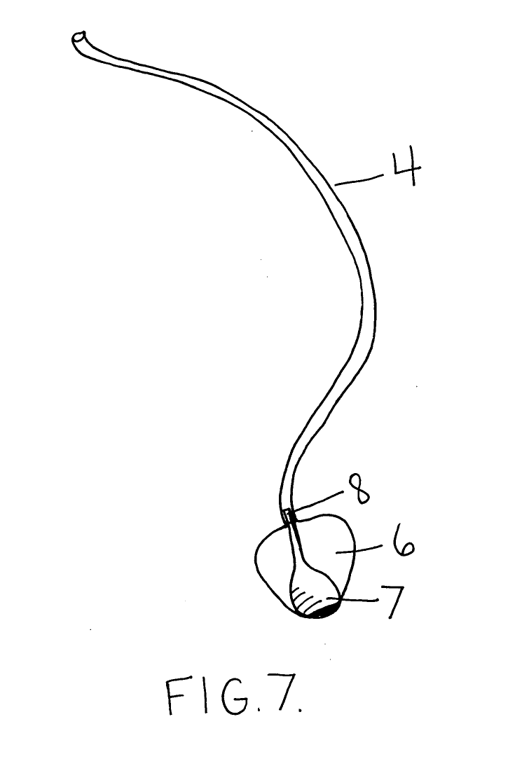

Although there are many sizes the weighted end 6 in FIG. 6. represents a much larger size weight 6.

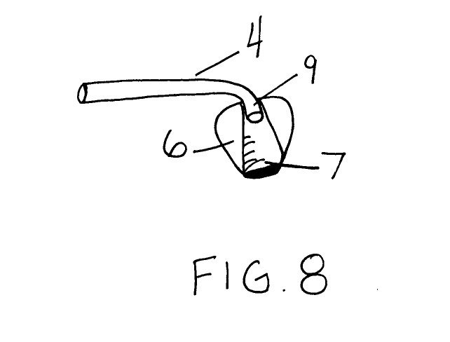

FIG. 7. shows the always spray tubing with weight as two pieces. The flexible tube 4 connects to the weighted end 6 which has a hole through the center 7 and a connection end 8. The connection end has a male adapter 8 which is connected to the inside of the flexible tubing 4. This invention can be made in two pieces depending on the application and its use.

FIG. 8 shows the always spray tubing with weight in two pieces. The flexible tube 4 is made shorter in this drawing to show the versatility in its many uses. The weighted end 6 has a hole through the center 7 and also can have a female connection 9. The flexible tubing 4 can be inserted into the weight 6 through a hole on the inside of the weight 6. It is shown in FIG. 8 by displaying the tubing 4 inside of the weight 6 and the tube inside the weight is represented by number 9.

The flexible tubing 4 either as one piece or two allows the weight 6 to move with the liquid 5. The weight 6 must be dense to remain submerged also allowing the hole 7 to be submerged as well regardless of the bottles orientations.

### OBJECTS AND ADVANTAGES

Accordingly, several objects and advantages of the always spray tubing with weight become evident:
1) It provides a much improved and need to replace the rigid dip tubes commonly used in many applications.
2) The ease in producing a constant flow of product or liquid is greatly desired by consumers and companies who may use this invention. It will be more cost efficient than prior art mentioned.
3) It can be made from many compatible manmade, dissolvable, or biodegradable materials which is great for consumer cost, and decreases environmental waste.
4) It can also be made, when applicable out of one piece which also lowers costs of manufacture and assembly.
5) It produces a higher yield of product.
6) Another advantage of Always Spray Tubing with Weight is there is less danger to consumers if it is installed before market sale if necessary.
7) The shape of the hole through the center of the weighted end can be modified to resemble a funnel, which can be used as a type of filter to stop unwanted debris if necessary in certain applications.

### CONCLUSION, RAMIFICATIONS, AND SCOPE OF THE INVENTION

Thus the reader will see that at least one embodiment of the always spray tubing with weight produces a more reliable, more cost effective, safe and economical replacement for the rigid dip tube previously used.

It can be used more easily by any person of almost any age to dispense a product from a dispensing device. It will produce a more constant flow of product regardless of the bottles orientation. It will allow product to be dispensed with less effort saving time and energy and also aggravation. While my above description contains many specificities, these should not be construed as limitations on the scope of the invention, rather as an exemplification of one or several preferred embodiments thereof. Many other variations are possible. Such variations include but are not limited to, parts being eliminated or duplicated, changed in size to being smaller or larger, made of different material, made of a different shape or color, connected or associated with its adjacent elements in a different manner and also given a different mode of function or operation. It also can be made integrally or separately Accordingly, the scope of the invention should not be determined by the embodiments illustrated, but by the appended claims and their legal equivalents.

The always spray tubing with weight will revolutionize the way we dispense products. It not only can be used for liquids in certain applications depending on size and shape of the weight and flexible tubing used, but can be used for dry substances as well.

I claim:

1. An article comprising of:
a) a flexible tube having two ends wherein one end is connected to a dispensing device, and
b) a weight which connects to the distal end of the flexible tube, wherein said weight has a hollow center that continues the length of the weight and a hole on the opposite end of the connection end to allow passage of liquid or substance through said flexible tube.

2. The flexible tube and weight of claim 1 wherein said tubing is very pliable which will allow said weight to move freely with the motion of the substance or liquid involved.

3. The flexible tube of claim 2 wherein said pliable tube is made of any manmade, biodegradable or dissolving material to coordinate with the substance or liquid involved in the application.

4. The flexible tube of claim 3 wherein said tube is made of appropriate materials for substance or liquid involved which will decrease or diminish possible chemical reaction when applicable.

5. The flexible tube of claim 1 wherein said tube would be cut to length or made to size according to substance or liquid and also with the size of container used to allow said weight proper movement and to remain submerged.

6. The weight of claim one wherein said weight is made of manmade, biodegradable or dissolving material to coordinate safely with the substance or liquid used in the application.

7. The weight of claim 6 wherein said weight could be made from multiple materials, as long as said weight is more dense than the substance or liquid involved which will allow weight to remain submerged.

8. The weight of claim 1 wherein said weight consists of a connection end will be sized to approximate dimensions needed for the connection to said flexible tube.

9. The weight of claim 1 wherein said weight has a hollow tube through the length of the weight with an appropriate diameter for the substance or liquid being used to allow liquid to pass through said flexible tube.

10. The hollow tube of claim 9 wherein said tube, although there are multiple shapes that would allow liquid to pass through, a funnel shape, larger on distal end of said connection end, could also serve as a debris blocker where applicable.

11. The flexible tubing with weight of claim 1 wherein said tube and weight are in two pieces can also be constructed as one piece when applicable.

12. The flexible tubing with weight of claim 11 wherein said tubing with weight can be made from one piece and made from any manmade, biodegradable, or dissolvable material safely compatible to substance or liquid used in the application.

13. The multiple material used of claim 12 wherein said tube must remain flexible to allow said weight to move freely with the motion of substance or liquid applied to.

14. The weighted end of the one piece of claim 11 wherein said weighted end will be more dense than liquid or substance applied to.
